(19) United States
(12) Patent Application Publication
(10) Pub. No.: US 2026/0136165 A1
(43) Pub. Date: May 14, 2026

(54) DIGITAL CONTROL NETWORK USING BROADCAST ISOCHRONOUS STREAMS

(71) Applicant: Silicon Laboratories Inc., Austin, TX (US)

(72) Inventors: Hasan Ali Stationwala, Hyderabad (IN); Manas Srivastava, Gurgaon (IN); Ayan Bandhu Ghosh, Dumdum (IN); Jitesh Rachamadugu, Hyderabad (IN)

(21) Appl. No.: 18/945,789

(22) Filed: Nov. 13, 2024

(51) Int. Cl. H04W 4/80; H04L 67/125

(52) U.S. Cl. CPC H04W 4/80; H04L 67/125

(57) ABSTRACT

A technique for controlling lighting devices uses a generic Bluetooth® Low Energy (BLE) protocol to wirelessly communicate digital control information from a controller to a peripheral device. The technique converts DMX frames of data into packets of a BLE Broadcast Isochronous Stream (BIS) for wireless communication using a wireless network having a star topology. Each peripheral device receives the same packets but acts on specific bytes in the packets. The peripheral device executes a received command after adjusting for a presentation delay as controlled by broadcast isochronous link. The technique provides for range extension using a relay mechanism and synchronizes peripheral devices using presentation delay. The technique maps a single DMX Universe to Protocol Data Units (PDUs) of a BIS and multiple DMX universes can be synchronized via multiple BIS of a single Broadcast Isochronous Group (BIG).

### BACKGROUND

### Field of the Invention

This disclosure relates to communications networks in general, and more particularly to communications in digital control networks.

### Description of the Related Art

An exemplary application (e.g., stage lighting, architectural lighting, event lighting, etc.) uses a standardized Digital Multiplex protocol (ANSI E1.11-2008 known as Entertainment Technology USITT DMX512-A, DMX, or DMX512, hereinafter “the DMX protocol”) having a data rate of 250 kilobits per second (kbps) using a wired, differential signaling physical layer. The DMX protocol is a variable-sized packet-based communication protocol for a controller or master device to send control information and data to one or more slave or peripheral devices (e.g., lighting fixtures) configured in a daisy-chain configuration. Each DMX peripheral device associated with a DMX universe (e.g., a single group of up to 512 channels that are controlled simultaneously to create complex and coordinated lighting effects) receives the same data packet. A data packet includes eight bits per channel (e.g., a value of 0 to 255). The receiver of a DMX peripheral device is programmed with information identifying the position of corresponding data in the data packet. In general, communications in a DMX universe are unidirectional (i.e., from the DMX controller to a DMX peripheral device), is limited to 512 channels, and lacks inherent error correction making the DMX protocol inappropriate for some applications (e.g., wired applications with relatively long cable runs, pyrotechnics, or movement of theatrical rigging). A digital control network compliant with the DMX protocol enables complex and coordinated effects (e.g., synchronized lighting effects, color changes, and automated control of lighting systems) to enhance ambiance or experience, or to create intricate lighting effects or patterns.

Referring to FIG. 1, an exemplary digital control network uses a wired, daisy-chain topology with cables 110, 112, and 114 coupling DMX controller 102 and DMX receivers 104, 106, and 108 in series. The physical layer uses the RS-485 (i.e., Telecommunications Industry Association (TIA)-485 or Electronics Industries Alliance (EIA)-485) standard that defines electrical characteristics of drivers and receivers in low-speed, serial communications systems (e.g., up to 10 Mbps) over distances of up to 1,200 m. Cables 110, 112, and 114 use XLR-5 (5-pin) or XLR-3 (3-pin) connectors. The maximum cable length is 300 meters without a repeater. The DMX protocol has little error handling and relies on continuous data transmission for redundancy.

DMX controller 102 is a master device that transmits DMX signals to a network of up to 512 DMX peripheral devices (e.g., dimmers, intelligent lights, or other DMX-compatible fixtures that receive and execute commands from a DMX controller). At the data link layer, DMX controller 102 sends data in frames, with each frame representing one universe (i.e., up to 512 channels). Each frame starts with a break (e.g., 88 microseconds or more), followed by a mark after break (8 microseconds) and then a start code (typically 0). Each channel has a value between 0 and 255 (i.e., eight bits) and controls parameters e.g., brightness, color, movement, etc. DMX receiver 104, 106, and 108 each inspect one or more channels of 512 channels to be controlled by the DMX controller. DMX receiver 104, DMX receiver 106, and DMX receiver 108 are associated with a unique address that determines which part of a DMX frame includes data relevant to the DMX receiver. DMX receiver 104 is the receiver of a first DMX peripheral device in the daisy-chain and acts upon the initial M bytes in a received frame and forwards the received frame, unchanged, to DMX receiver 106. DMX receiver 106 acts upon the next N bytes and forwards the received frame, unchanged, to DMX receiver 108. DMX receiver 108 acts upon the next L bytes of the received frame.

In practice, the daisy-chain configuration of a DMX network can impact performance due to the sequential data flow through the peripheral devices. Continuous data transmission can be power inefficient. Accordingly, a wireless network for lighting applications with range extension and synchronization between peripheral devices is desired.

### SUMMARY OF EMBODIMENTS OF THE INVENTION

In at least one embodiment, a method for communicating data in a network of a plurality of lighting devices includes partitioning a frame of data for a predetermined number of channels into multiple Protocol Data Units (PDUs). Each channel of the predetermined number of channels has a predetermined bit width. The method includes transmitting a broadcast isochronous stream (BIS) including the multiple PDUs. The BIS has a plurality of subevents, each subevent of the plurality of subevents is associated with at least one corresponding channel of the predetermined number of channels. Each channel of the predetermined number of channels may be associated with a corresponding peripheral device of a plurality of peripheral devices. The predetermined number of channels may correspond to a Digital Multiplex (DMX) universe associated with the BIS. The method may include partitioning a second frame of data for a second predetermined number of channels into second multiple PDUs. The second predetermined number of channels may correspond to a second DMX universe associated with a second BIS. The BIS and the second BIS may be transmitted as part of a BIG. The method may include receiving the BIS by a first peripheral device, receiving the BIS by a second peripheral device, and using presentation delay to synchronously execute a command in the multiple PDUs by the first peripheral device and a second command in the BIS by the second peripheral device. The method may include receiving the BIS, and selectively processing a subevent of the plurality of subevents and ignoring other subevents of the plurality of subevents. The method may include retransmitting multiple PDUs of the BIS by a first peripheral device and executing a command in the subevent by the first peripheral device and a second command in another subevent of the plurality of subevents by a second peripheral device at a time after retransmission of the multiple PDUs by the first peripheral device. The time may be based on a first presentation delay and a second presentation delay.

In at least one embodiment, a network includes a controller configured to partition a frame of data for a predetermined number of channels into multiple PDUs. Each channel of the predetermined number of channels has a predetermined bit width. The controller is configured to transmit a BIS including the multiple PDUs. The BIS has a plurality of subevents. Each subevent of the plurality of subevents is associated with at least one corresponding channel of the predetermined number of channels. Each channel of the predetermined number of channels may be associated with a corresponding peripheral device of a plurality of peripheral devices. The predetermined number of channels may correspond to a DMX universe associated with the BIS. The controller may be further configured to partition a second frame of data for a second predetermined number of channels into second multiple PDUs. The second predetermined number of channels may correspond to a second DMX universe associated with a second BIS. The controller may be further configured to transmit the BIS and the second BIS as part of a BIG. The network may further include a first peripheral device configured to receive the BIS and a second peripheral device configured to receive the BIS. The first peripheral device and the second peripheral device may be further configured to use presentation delay to synchronously execute a command in the BIS and a second command in the BIS, respectively. The network may further include a first peripheral device configured to receive the BIS, selectively process a subevent of the plurality of subevents, and ignore other subevents of the plurality of subevents. The first peripheral device may be configured to retransmit multiple PDUs of the BIS, and to execute a command in the multiple PDUs. A second peripheral device may be configured to execute a second command in the multiple PDUs at a time after transmission of the multiple PDUs by the first peripheral device. The time may be based on a first presentation delay and a second presentation delay.

In at least one embodiment, a method for communicating data in a network of a plurality of lighting devices includes receiving a BIS including a plurality of subevents. Each subevent of the plurality of subevents is associated with at least one corresponding channel of a predetermined number of channels of a frame of data. Each channel of the predetermined number of channels has a predetermined bit width. The method includes selectively processing a first subevent of the plurality of subevents and ignoring other subevents of the plurality of subevents. The method may include retransmitting the plurality of subevents by a first peripheral device. The method may include executing a command in the first subevent by the first peripheral device and a second command in another subevent of the plurality of subevents by a second peripheral device at a time after transmission of the BIS by the first receiver. The time may be based on a first presentation delay and a second presentation delay.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of a wired network of DMX devices configured in a daisy-chain topology according to a DMX protocol.

FIG. 2 illustrates a functional block diagram of a wireless network of a controller and peripheral devices coupled to a broadcast isochronous link in a star topology consistent with at least one embodiment of the invention.

FIG. 3 illustrates a functional block diagram of a wireless network of a controller and peripheral devices coupled to a broadcast isochronous link in a star topology and including an adaptor for compatibility with a DMX receiver consistent with at least one embodiment of the invention.

FIG. 4 illustrates a functional block diagram of a wireless network of a controller and peripheral devices in a tree topology consistent with at least one embodiment of the invention.

FIG. 5 illustrates a functional block diagram of wireless network of a controller and peripheral devices including synchronized controllers consistent with at least one embodiment of the invention.

FIG. 6 illustrates a functional block diagram of a wireless network of a controller and peripheral devices coupled to a broadcast isochronous link and listening to specific sub-events consistent with at least one embodiment of the invention.

FIG. 7 illustrates a functional block diagram of a wireless network of a controller and peripheral devices coupled to a broadcast isochronous link with partial redundancy consistent with at least one embodiment of the invention.

FIG. 8 illustrates a functional block diagram of a wireless network of a controller and peripheral devices coupled to a broadcast isochronous link with partial reception of data consistent with at least one embodiment of the invention.

FIG. 9 illustrates a functional block diagram of a wireless network of a controller and peripheral devices coupled in an array consistent with at least one embodiment of the invention.

FIG. 10 illustrates a functional block diagram of a controller and peripheral devices of the configuration of FIG. 2.

FIG. 11 illustrates a functional block diagram of portions of an exemplary device of FIG. 10 configured for BLE communications and delivery of isochronous data.

FIG. 12 illustrates an exemplary state diagram of a link layer implemented by a link controller of FIG. 11.

FIG. 13 illustrates a format of a BIS packet.

FIG. 14 illustrates a functional block diagram of a portion of an exemplary device of FIGS. 10 and 11 for delivery of isochronous data.

FIG. 15 illustrates an information and control flow of a digital control network consistent with at least one embodiment of the invention.

FIG. 16 illustrates a functional block diagram of a wireless network of a controller and a speaker and light-emitting diode devices consistent with at least one embodiment of the invention.

The use of the same reference symbols in different drawings indicates similar or identical items.

### DETAILED DESCRIPTION

A technique for controlling lighting devices uses a generic Bluetooth® Low Energy (BLE) protocol to wirelessly communicate digital control information from a controller to a peripheral device. The technique converts DMX frames of data into packets of a BLE Broadcast Isochronous Stream (BIS) for wireless communication using a wireless network having a star topology. Each peripheral device receives the same packets but acts on specific bytes in the packets. The peripheral device executes a received command after adjusting for a presentation delay as controlled by broadcast isochronous link. The technique provides for range extension using a relay mechanism and synchronizes peripheral devices using presentation delay. The technique maps a single DMX Universe to Protocol Data Units (PDUs) of a BIS and multiple DMX universes can be synchronized via multiple BIS of a single Broadcast Isochronous Group (BIG). In at least one embodiment, the peripheral devices do not retransmit the PDUs since each peripheral device is assumed to be within the range of controller and can listen to the original transmission. In at least one embodiment, peripheral devices retransmit the PDUs and serve as repeaters to extend the range of operation. In at least one embodiment, transmitters are synchronized using common network timing. In at least one embodiment receivers are synchronized using a presentation delay parameter.

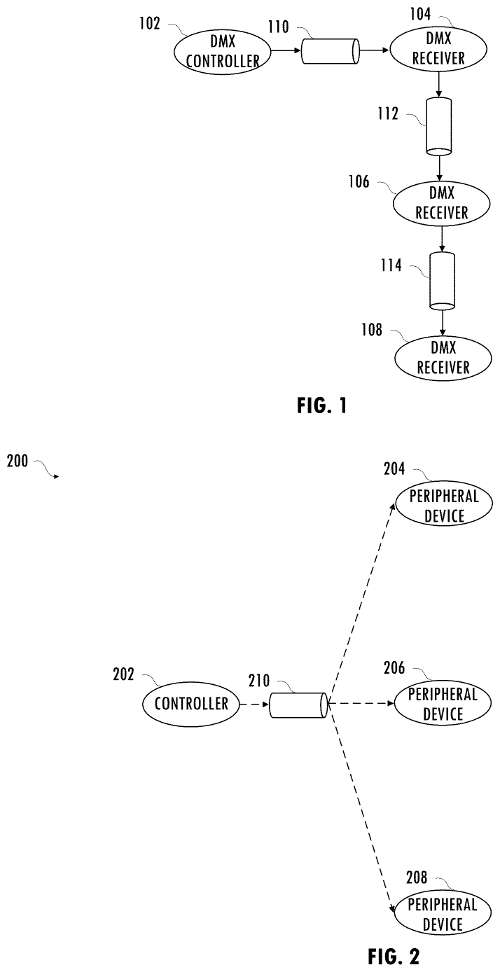

Referring to FIG. 2, a digital control network, which may be used in lighting applications, has a star topology instead of the daisy-chain topology described above. Controller 202 provides each peripheral device in the network with broadcast data packets transmitted using broadcast isochronous link 210, consistent with the BLE controller specification. Each of peripheral device 204, peripheral device 206, and peripheral device 208 receives the same PDUs but acts on only corresponding bytes in the PDUs and ignores other bytes in the PDUs to be consistent with the DMX protocol. A peripheral device executes a received command after adjusting for a presentation delay as controlled by the broadcast isochronous link. In the embodiment of FIG. 2, peripheral device 204, peripheral device 206, and peripheral device 208 do not retransmit the PDUs since each peripheral device of network 200 is within the range of control integrated circuit 1102 and can listen to the original transmission from control integrated circuit 1102. The BIS corresponds to a single DMX universe. Peripheral device 204 acts upon the initial M bytes of the BIS PDUs, peripheral device 206 acts upon the next N bytes of the BIS PDUs, and peripheral device 208 acts upon the next L bytes of the BIS PDUs.

In general, a DMX controller transmits a frame of data every 22.7 milliseconds (i.e., 44 frames per second). Assuming a frame size of 512 bytes (i.e., the maximum frame size supported by DMX), controller 202 fragments a single frame (i.e., Service Data Units (SDU)) into three BIS PDUs. In an embodiment, the physical interface is a conventional 1 Megabit per second BLE physical interface, and for three PDUs, the total interframe space (i.e., T_IFS) overhead is 450 microseconds, the total preamble overhead is 120 microseconds, the total BLE header and CRC overhead is 120 microseconds (i.e., 5 Bytes×8 bits×3 PDUs). The total duration for 512 Bytes transmitted using the 1 Megabit per second BLE physical interface is 4096 microseconds (i.e., 512×8) and the total SDU duration is 4.8 milliseconds. In at least one embodiment, each frame is retransmitted four times for improving reliability and a total of 19.2 milliseconds is required. In an embodiment, controller 202 reserves 3.5 milliseconds for other BLE protocol overhead for advertisement. Accordingly, controller 202 can support up to 1 DMX universe. In other embodiments, controller 202 supports an additional DMX universe by reducing the number of retries of a broadcast packet.

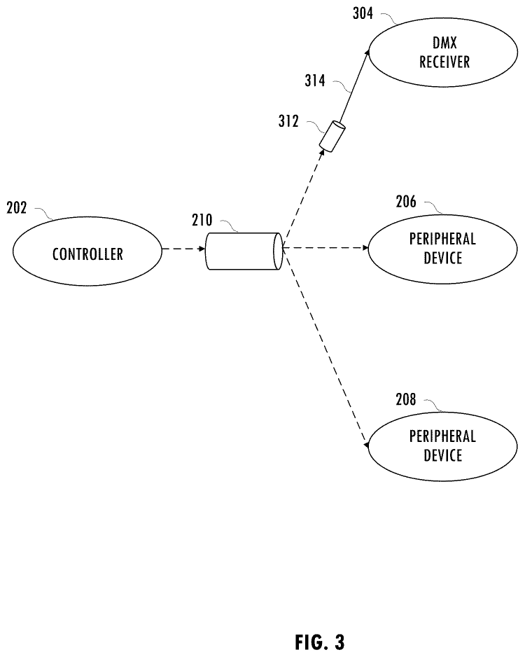

Referring to FIG. 3, in at least one embodiment, adapter 312 provides compatibility with DMX receiver 304 by receiving a BIS over broadcast isochronous link 210 and forwarding DMX frames to DMX receiver 304 over cable 314 using the RS-485 protocol. Adapter 312 drives the signal over cable 314 after adjusting for presentation delay recommended by the broadcast isochronous link to ensure that DMX receiver 304 and peripheral devices 206 and 208 execute the received frame at the same time. In an embodiment, controller 202 sets a presentation delay parameter value in an announcement (e.g., an announcement defined of a Basic Lighting Profile or a Basic Audio Announcement of the Basic Audio Profile) used to inform scanning devices of parameters of a BIS. The presentation delay parameter controls the precise timestamp at which isochronous data is to be delivered (e.g., executed or played back) after reception. Controller 202 sets the presentation delay parameter to a value that is expected to be in a range of capabilities of all broadcast sinks expected to synchronize to a BIS broadcast from controller 202. The value includes any implementation specific delays in a broadcast sink device, e.g., processing time for internal transports, codec processing, ADC/DAC delays, application-specific audio processing, or other system delay of controller 202 or peripheral device 204, 206, or 208. For example, controller 202 sets the presentation delay to a time when lighting data is to be executed back by every peripheral device, e.g., a time in microseconds after a timestamp corresponding to synchronization point. In at least one embodiment, the synchronization point is a SDU Synchronization Reference of the Basic Lighting Profile. In at least one embodiment the presentation delay is specified using three octets (e.g., 0x000000 to 0xffffff) defining a predetermined delay range. In at least one embodiment, wireless controller 202 reads a minimum and maximum presentation delay of a broadcast sink device (e.g., peripheral device 204, 206, or 208) during configuration and sets a presentation delay value to be greater than the highest presentation delay minimum of the broadcast sink devices and lower than the lowest presentation delay maximum of broadcast sink devices listening to a broadcast from wireless communications device.

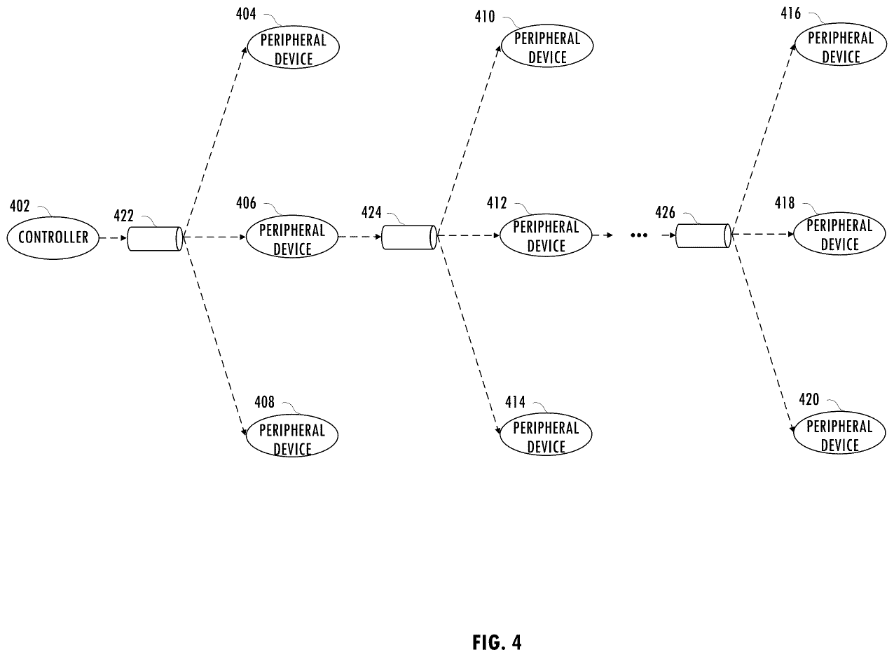

Referring to FIG. 4, in at least one embodiment of a network, all peripheral devices are not within the range for direct wireless communications with controller 402 and a tree-based topology is used to extend the range of communications. Controller 402 uses broadcast isochronous link 422 to wirelessly communicate with peripheral devices 404, 406, and 408 of a first network hop. Range extension is achieved by peripheral device 406 retransmitting the PDUs received in the BIS to peripheral devices 410, 412, and 414 within range of controller 402 via broadcast isochronous link 424 and at least one additional network hop retransmitting the PDUs received in a second BIS to peripheral devices 416, 418, and 420 via broadcast isochronous link 426. Each network hop adjusts the command execution timing using presentation delay to achieve command execution synchronization. A technique extends the range of synchronized delivery of isochronous data (e.g., execution of broadcast lighting signals) beyond the range of a source wireless communications device (e.g., a source BLE controller device) by configuring multiple wireless communications devices (e.g., multiple peripheral devices) in a relay network and increasing the presentation delay of the source wireless communications device by an amount that includes a presentation delay of each additional peripheral device in the relay network. The mechanism relays the isochronous data across multiple hops and updates corresponding presentation delays such that the isochronous data is delivered (e.g., played back) at a precise instant on all peripheral devices in the network, regardless of the number of hops between a controller and a final peripheral device of the relay network that delivers the isochronous data.

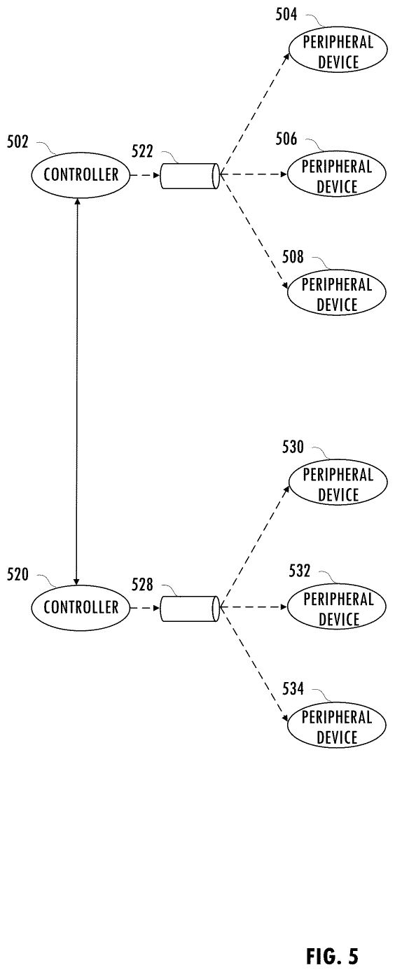

Referring to FIG. 5, in at least one embodiment of a digital control network, all peripheral devices are not within range for wireless communications with controller 502 and multiple controllers are used to extend the range of communications. Controller 502 uses broadcast isochronous link 522 to communicate with peripheral devices 504, 506, and 508. Range extension is achieved by synchronizing controller 502 and controller 520, which uses broadcast isochronous link 528 to communicate with peripheral devices 530, 532, and 534. Each controller is coupled to another controller by a wired network and is synchronized to a common network timestamp. Each controller wirelessly communicates with peripheral devices in its wireless communications range using a BIS.

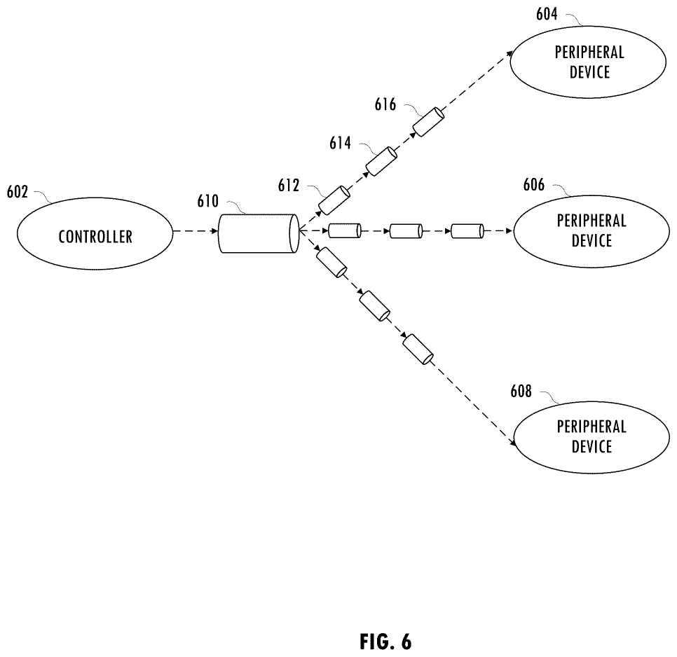

Referring to FIG. 6, in at least one embodiment, controller 602 uses broadcast isochronous link 610 to transmit a BIS that includes an SDU of up to 512 bytes by partitioning the SDU into one or more separate PDUs that each include up to 251 bytes of data from the SDU. Controller 602 partitions the SDU into PDUs 612, 614, and 616 that are transmitted in subevents of the BIS. Each subevent is associated with a unique identifier corresponding to a DMX channel of a DMX universe. Peripheral devices 604, 606, and 608 each receive the multiple PDUs but are only interested in specific channels of the associated DMX universe and thus, need not listen to all the PDUs. Accordingly, peripheral devices 604, 606, and 608 identify and listen to a specific subevent of a BIS that carries a PDU of interest and ignore the other subevents of the BIS. An application executing on a corresponding peripheral device configures that peripheral device to listen to a predetermined channel of a DMX universe. That predetermined channel is identified by information loaded to a configuration register from pins, fuses, firmware-defined values, or a configuration received from controller 602 by firmware during message exchanges between controller 602 and peripheral devices 640, 606, and 608 of system initialization (e.g., using BLE connected mode or out-of-band communications).

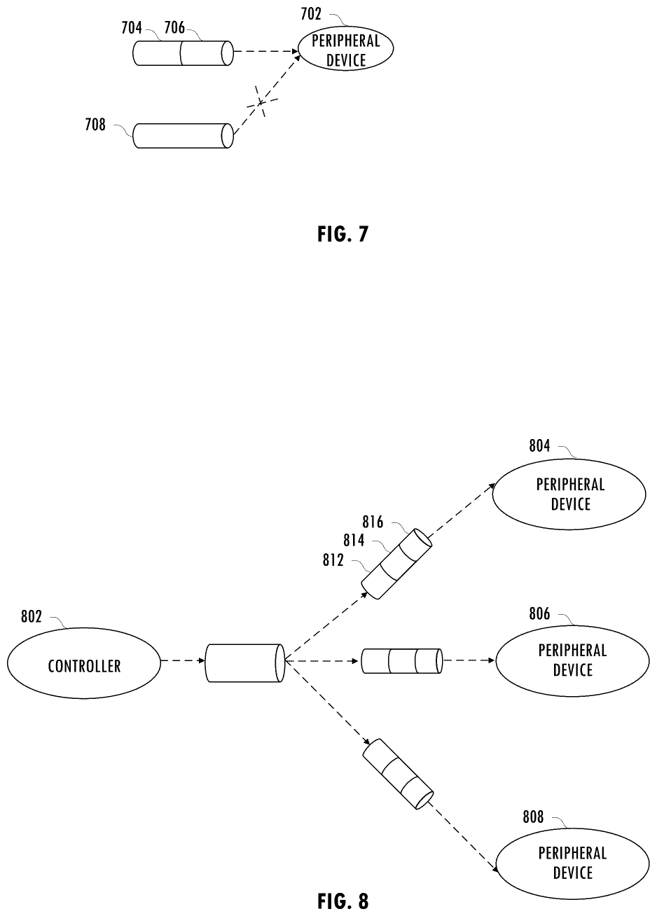

In at least one embodiment, although each peripheral device listens to an entire BIS, each peripheral device is interested in only specific channels and ignores other channels. Accordingly, redundancy and redundancy checks are calculated on subsets of events of a BIS, e.g., on individual PDUs of interest to the peripheral device. Therefore, the peripheral device needs not listen to retransmissions of a previously corrupted packet that only carries information for channels that are not of interest to the peripheral device. For example, referring to FIG. 7, peripheral device 702 is interested in subevent 706 and not in subevent 704. If subevent 704 is corrupted and retransmission 708 of the PDUs corresponding to subevents 704 and 706 is received, then peripheral device 702 discards the retransmitted PDUs without decoding or otherwise processing the data. Thus, peripheral device 702 reduces its power consumption under some circumstances.

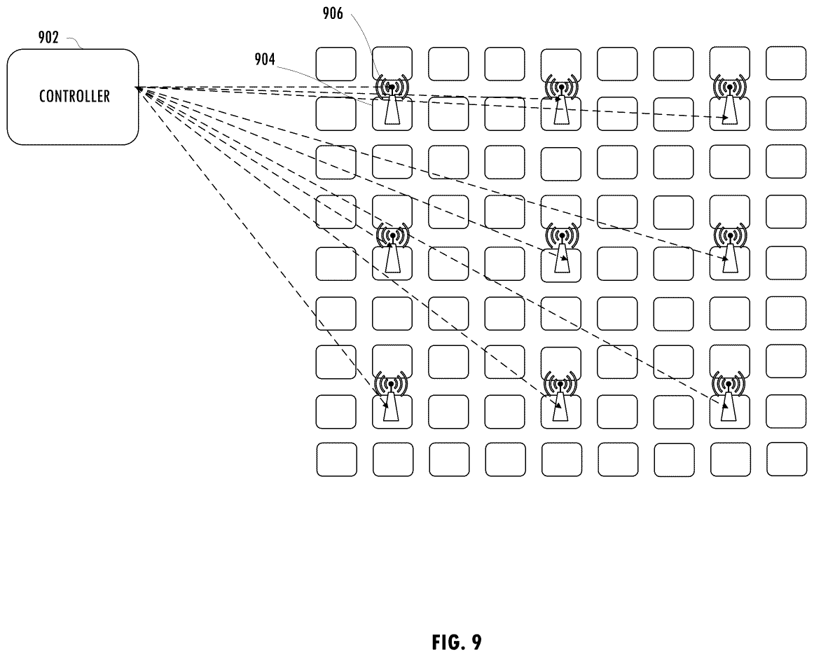

In at least one embodiment, controller 802 cyclically updates the sets of DMX channels of interest to a peripheral device in BIS subevents. The peripheral device uses a BIS counter and a predetermined location identifier to determine the location of the channel(s) of interest in BIS subevents. By rotating the location of the channel(s) of interest in a BIS event (i.e., rotate the subevent of a BIS event used by different channels), each peripheral device has an equal opportunity to reduce power consumption by having the opportunity to receive data over a channel in a BIS subevent that passes the associated redundancy checks and to discard data received on other channels. For example, referring to FIG. 8, in an embodiment, peripheral device 804 is interested in data in subevent 812 of a BIS, peripheral device 806 is interested in data in subevent 814 of the BIS, and peripheral device 808 is interested in data in subevent 816 of the BIS. For a next event of the BIS, peripheral device 804 is interested in data in subevent 814, peripheral device 806 is interested in data in subevent 816, and peripheral device 808 is interested in data in subevent 812. Accordingly, peripheral devices 804, 806, and 808 each have the opportunity to use each location of a BIS and reduce power consumption when able to ignore retransmissions for data not of interest to the peripheral device.

Referring to FIG. 9, in an exemplary application, an array of peripheral devices receives data from controller 902 and the peripheral devices synchronously execute events based on command data in a received BIS. In an exemplary application, arrays of light-emitting diodes (LEDs) are configured in sticks that are reusable, programmable handheld devices. Controller 902 configures corresponding LED arrays in its vicinity using wireless peripheral devices 906. In an embodiment, each LED stick 904 is configured to listen to a specific subevent of a BIS after acquiring a precise seat position in an arena. Each LED stick 904 wirelessly receives commands from controller 902 to execute commands simultaneously to create patterns or other lighting effects during a performance.

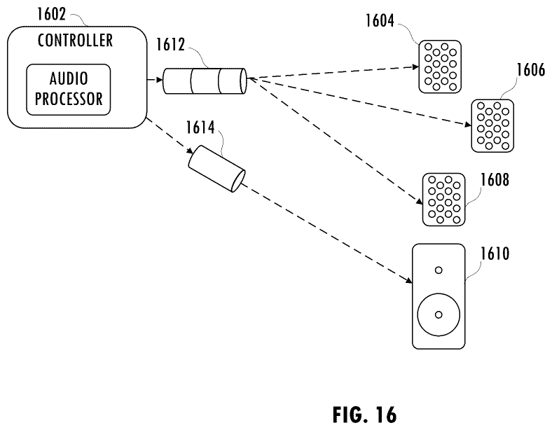

Referring to FIG. 16, in an exemplary application, a plurality of peripheral devices includes heterogeneous peripheral devices that synchronously present or execute distinct but related isochronous data to achieve an integrated result. For example, a lighting system is controlled by a stream of lighting data transmitted using a BIS as described above. Red LED light 1606, blue LED light 1604, and green LED light 1608 are associated with corresponding subevents in stream 1610 and associated with corresponding channels of DMX data. An audio system is controlled by stream 1612 of audio data for playback by loudspeaker 1608 and transmitted using a packet in conformance with BIS or a Connected Isochronous Stream (CIS). Controller 1602 includes an audio processing system that generates the DMX data based on an audio file. The Generic Lighting Framework and Basic Lighting Profile include additional information and procedures for controlling an audio stream (e.g., information and procedures of Generic Audio Framework (GAF) and Basic Audio Profile (BAP) or other information and procedures consistent with techniques described in U.S. patent application Ser. No. 18/193,928, entitled “Audio Streaming Using Relay Network,” naming Hasan Ali Stationwala and Ayan Ghosh as inventors, and filed on Mar. 31, 2023, which application is incorporated herein by reference). In at least one embodiment, an audio codec or other elements of the audio processing system analyzes the audio file and generates an RGB lighting equivalent based on the energy spectrum of the audio file using any suitable translation (e.g., different colors represent different audio frequencies and are configured to have intensities based on the energy content of the corresponding frequencies). The distinct isochronous streams are transmitted to achieve synchronized execution at the peripheral devices.

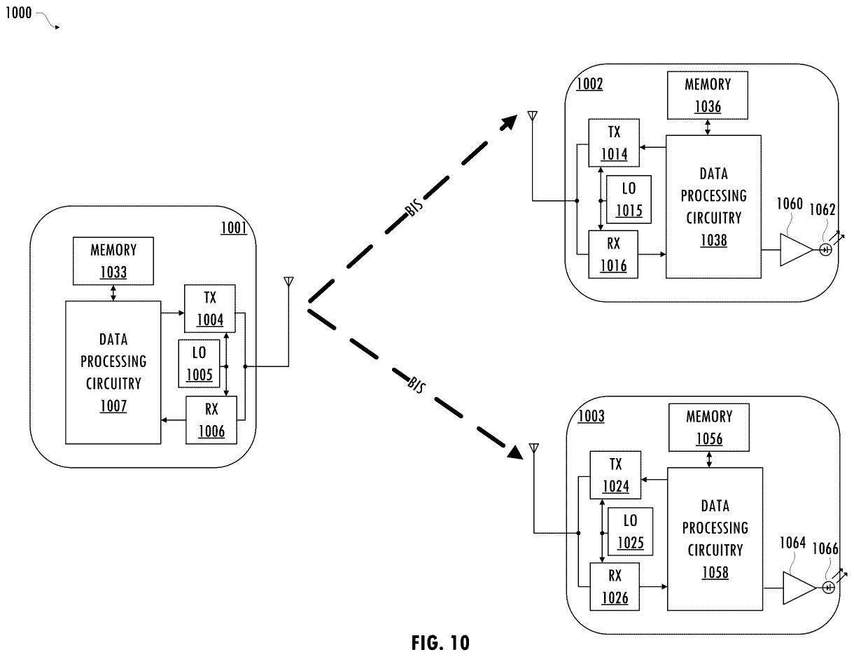

Referring to FIG. 10, in at least one embodiment, control network 1000 includes controller 1001, peripheral device 1002, and peripheral device 1003, which are wireless devices compliant with the is compliant with Bluetooth Core Specification Version 5.2 or later. Controller 1001 includes transmitter 1004, receiver 1006, data processing circuitry 1007, memory 1033, and local oscillator 1005. Peripheral device 1002 includes transmitter 1014, receiver 1016, data processing circuitry 1038, memory 1036, and local oscillator 1015. Peripheral device 1003 includes transmitter 1024, receiver 1026, data processing circuitry 1058, memory 1056, and local oscillator 1025. Local oscillator 105, local oscillator 1015, and local oscillator 1025 provide signals used in transceiver functions of controller 1001, peripheral device 1002, and peripheral device 1003, respectively.

In an embodiment of control network 1000, controller 1001, peripheral device 1002, and peripheral device 1003 are BLE lighting devices (e.g., light controller or peripheral device, which may include a dimmer, intelligent light, or DMX compatible fixture) and data processing circuitry 1038 and data processing circuitry 1058 provide signals to driver 1060 and driver 1064, respectively, which drive LED 1062 and LED 1066, respectively, to generate light. Additional wireless communications devices (not shown) of control network 1000 are similar to controller 1001, peripheral device 1002, and peripheral device 1003.

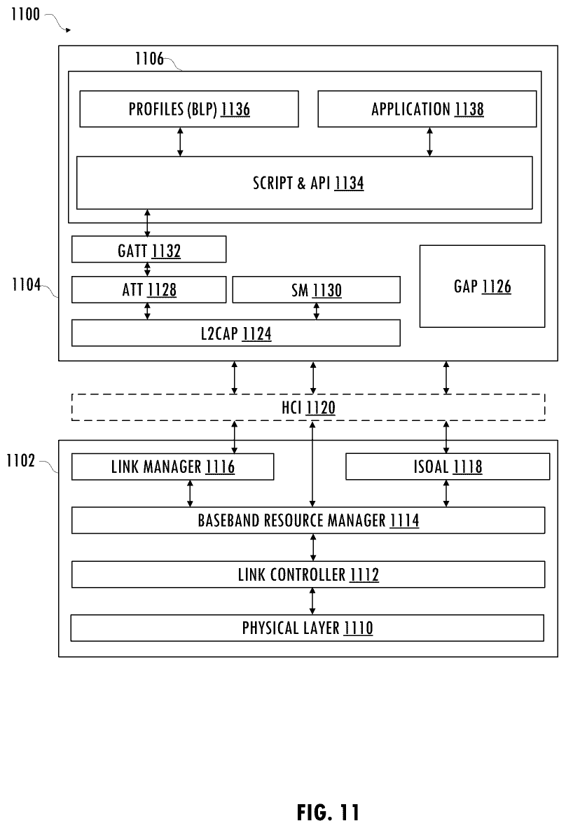

In at least one embodiment of peripheral device 1002, transmitter 1014, receiver 1016, local oscillator 1015, data processing circuitry 1038, and memory 1036 are included in a controller implementing a link layer of a BLE device and implementing a physical layer (RF and PHY), which controls radio frequency communications. Referring to FIG. 11, each wireless communications device of a BLE communications system implements the BLE architecture, e.g., using separate integrated circuit devices for control integrated circuit 1102 and host circuit 1104. In some embodiments, wireless communications device 1100 incorporates functionality of control integrated circuit 1102 and host integrated circuit 1104 in a single integrated circuit device. Control integrated circuit 1102 includes physical layer (e.g., RF radio) 1110 and link controller 1112, which are responsible for sending or receiving packets over the air by defining the use of a radio, including modulation schemes, frequency bands, channel use, and transmitter and receiver characteristics, e.g., as described in Bluetooth Core Specification Version 5.3, Vol. 6: Low Energy Controller. Physical layer 1110 transmits and receives packets of information using the physical channel and transforms a stream of data to and from the physical channel and the baseband into required formats. The physical layer defines the use of a radio (e.g., the transmitter and receiver described above), including modulation schemes, frequency bands, channel use, and transmitter and receiver characteristics. Link controller 1112 implements a link layer protocol, which defines the air interface packet formats, bit stream processing procedures, a state machine and protocols of over-the-air communication, and link control. Link controller 1112 encodes and decodes packets from a data payload and parameters related to a physical channel, logical transport, and logical link.

Baseband resource manager 1114 negotiates access contracts, i.e., commitments to deliver a predetermined QoS that is required by a user application to provide expected performance. Baseband resource manager 1114 also includes a scheduler that grants time on physical channels to entities that have negotiated an access contract. Isochronous Adaptation Layer (ISOAL) 1118 converts between upper layer data units and lower layer data units, e.g., using fragmentation and recombination or segmentation and reassembly operations. ISOAL allows the size of isochronous data packets as created and consumed by upper layers of the architecture to be different from the size of data packets used by the link layer. In addition, ISOAL allows an upper layer to use timing intervals that differ from those used by the link layer so that the rate of Service Data Units (SDUs) exchanged with the upper layers is not the same as the rate with which they are exchanged with the link layer. Link manager 1116 creates, modifies, and releases logical links (and associated logical transports, if required) and updates parameters related to physical links between devices. In an embodiment, wireless communications device 1100 implements Host-to-Controller Interface (HCl) 1120, which is a standard service interface.

In an embodiment, host integrated circuit 1104 includes Generic Lighting Framework (GLF) 1106, Logical Link Control and Adaptation Protocol (L2CAP) resource manager 1124, Attribute Protocol (ATT) 1128, Generic Attribute Protocol (GATT) 1132, Generic Access Profile (GAP) 1126, and Security Manager (SM) 1130. L2CAP resource manager 1124 manages ordering of submission of BLE packet protocol data unit (PDU) fragments and some relative scheduling between channels to ensure that L2CAP channels with QoS commitments are not denied access to the physical channel due to controller resource exhaustion. L2CAP resource manager 1124 polices traffic to ensure that applications submit L2CAP SDUs within bounds of negotiated QoS settings. In an exemplary wireless communications device 1100, GATT 1132 defines the way that two BLE devices communicate data using services and characteristics. In an embodiment, GATT 232 uses a generic data protocol stored in ATT 1128, which is used to store services, characteristics and related data in a simple lookup table using 16-bit identifiers for each entry in the table. SM 1130 implements a peer-to-peer protocol for generating encryption keys and identity keys and generates random addresses and resolves random addresses to known device identities. SM 1130 provides stored keys to control integrated circuit 1102 for encryption and authentication during encryption or pairing procedures.

GAP 1126 represents base functionality common to all Bluetooth devices, e.g., modes and access procedures used by transports, protocols, and application profiles. GAP services include device discovery, connection modes, security authentication, associate models and service discovery. GLF 1106 includes Script and API 1134, application 1138 (e.g., lighting control application), and profiles 1136, which adds application specific information to GLF 1106. For example, profiles 1136 include a lighting control profile, e.g., as described in Basic Lighting Profile (BLP), which defines procedures for controlling lighting streams by using GATT 1132 and GAP 1126 for devices that use BLE in lighting-related scenarios. For example, the BLP sets up and manages broadcast lighting control streams, e.g., using an application layer state machine for each individual isochronous channel that transitions between idle, configured, and streaming states. In an embodiment, profiles 1136 also includes profiles 1136 includes a public broadcast profile (PBP), which facilitates selecting globally interoperable broadcast systems.

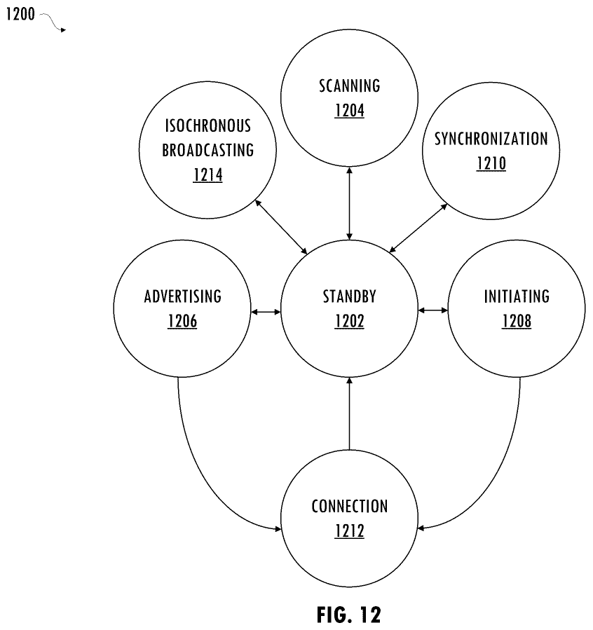

FIG. 12 illustrates an exemplary state machine implemented by the link layer of wireless communications device 1200 (e.g., a controller or peripheral device described above) including standby state 1202, scanning state 1204 or advertising state 1206, initiating state 1208, synchronization state 1210, connection state 1212, and isochronous broadcasting state 1214. Only one state of the link layer is active at a time. Link layer state machine 1200 can enter standby state 1202 from any other state. In standby state 1202, the link layer does not transmit any packets. Link layer state machine 1200 may enter advertising state 1206 from standby state 1202. In advertising state 1206, the link layer transmits advertising physical channel packets and may listen to and respond to a response triggered by the advertising physical channel packets. In at least one embodiment, the link layer transmits periodic advertising PDUs, which expose broadcast lighting control stream parameters, including presentation delay.

Link layer state machine 1200 may enter scanning state 1204 from standby state 1202. In scanning state 1204, the link layer listens for advertising physical channel packets from devices that are advertising. Link layer state machine 1200 may enter initiating state 1208 from standby state 1202. In initiating state 1208, the link layer listens for advertising physical channel packets from a specific device and responds to these packets to initiate a connection. Link layer state machine 1200 may enter synchronization state 1210 from standby state 1202. In synchronization state 1210, the link layer listens for periodic channel packets forming a specific periodic advertising train transmitted by a specified device (e.g., a host may direct the link layer to listen for isochronous data packets coming from a specified device that is transmitting a broadcast isochronous group (BIG)). Link layer state machine 400 may enter isochronous broadcasting state 1214 from standby state 1202. In isochronous broadcasting state 1214, the link layer transmits isochronous data packets on an isochronous physical channel.

Link layer state machine 1200 may enter connection state 1212 from initiating state 1208 or advertising state 1206. When entering connection state 1212 from initiating state 1208, the connection state is the central role (i.e., the wireless communications device is configured as a central device) and the wireless communications device communicates with another wireless communications device having a connection state of a peripheral role (i.e., the other wireless communications device is configured as a peripheral device) and defines the timings of transmissions. When entering connection state 1212 from advertising state 1206, the connection state is the peripheral role and the link layer communicates with a single other wireless communications device configured in the central role. In some embodiments, during connection state 1212, the link layer transmits data physical channel PDUs in connection events. A connection event typically contains at least one packet sent by the central device. The same data channel index is used for all packets in a connection event. In some embodiments, during a connection event, the central device and peripheral device alternate sending and receiving packets.

In an embodiment, the link layer uses one physical channel (RF channel) at a time. Each transmission on a physical channel is associated with corresponding access address. In general, two wireless communications devices use a shared physical channel to communicate with each other. Whenever the link layer of a wireless communications device is synchronized to the timing, frequency, and access address of a physical channel, the link layer is connected on the data physical channel or synchronized to a periodic physical channel or an isochronous physical channel regardless of whether it is actively involved in communications over the channel.

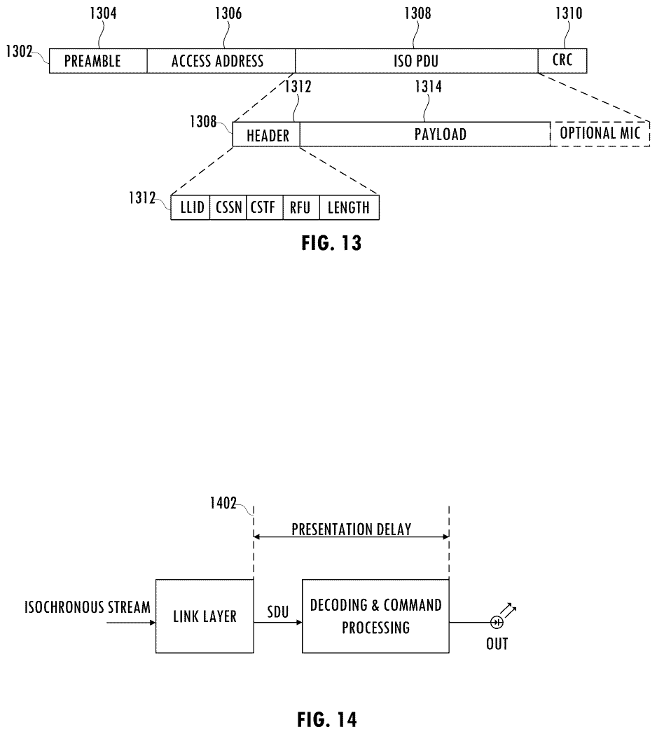

FIG. 13 illustrates an exemplary BLE BIS radio packet for transmitting data by a wireless communications device. BIS packet 1302 includes preamble 1304 (e.g., 1 or 2 octets), access address 1306 (e.g., 4 octets), isochronous PDU 1308 (e.g., 2-257 octets), and CRC 1310 (e.g., 3 octets). Isochronous PDU 1308 includes header 1312 (e.g., 16 bits), payload 1314 (e.g., 0-251 octets), and an optional Message Integrity Check (e.g., 32 bits). Header 1312 includes Link Layer ID (e.g., 2 bits), Control Subevent Sequence Number (e.g., 3 bits), Control Subevent Transmission Flag (e.g., 1 bit), Reserved for Future Use (RFU) bits (e.g., 2 bits), and Length (e.g., 8 bits). The CSTF bit signals that a control subevent is present in that BIS event. The control subevent provides control information to every sink device and is used to inform the sink device of events such as a change in hopping sequence.

Referring to FIG. 14, in at least one embodiment, a controller that transmits a BIS sets a presentation delay parameter value in a Broadcast Lighting Source Endpoint (BLSE) in an announcement (e.g., a Basic Lighting Announcement of the Basic Lighting Profile) used to inform peripheral devices of parameters of a BIS. The presentation delay parameter controls the precise timestamp at which isochronous data (e.g., lighting control data) is to be executed after reception by the peripheral device. The controller sets the presentation delay parameter to a value that is expected to be in a range of capabilities of all peripheral devices expected to synchronize to a BIS broadcast from the controller. The value includes any implementation specific delays in a peripheral device, e.g., processing time for internal transports, signal processing, ADC/DAC delays, application-specific signal processing, or other system delay of a peripheral device. For example, a controller sets the presentation delay to a time when lighting control data is to be executed by every peripheral device, e.g., a time in microseconds after a timestamp corresponding to synchronization point 1402. In at least one embodiment, synchronization point 1402 is the SDU Synchronization Reference of the BLP specification. In at least one embodiment the presentation delay is specified using three octets ranging from 0 to 16.7 sec in μs (0x000000 to 0xffffff). In at least one embodiment, the controller reads a minimum and maximum presentation delay of a peripheral device during configuration and sets a presentation delay value to be greater than the highest presentation delay minimum of the peripheral devices and lower than the lowest presentation delay maximum of peripheral devices listening to a broadcast from the controller.

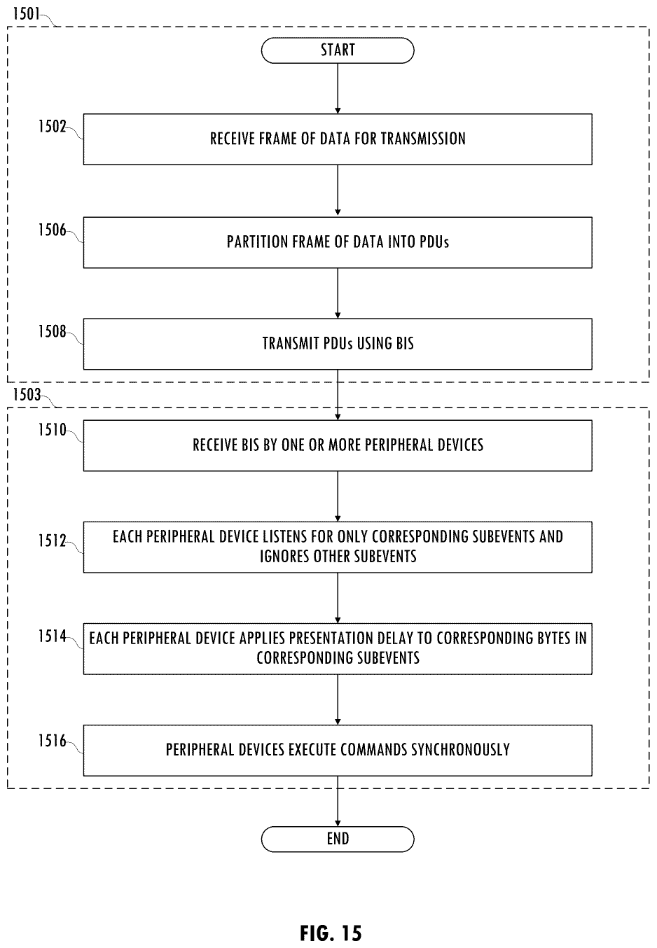

Referring to FIG. 15, in at least one embodiment, a controller performs operations 1501 and a peripheral device within wireless communications range of the controller performs operations 1503. The controller receives a frame of lighting control data for transmission in a format consistent with DMX protocol (1502), partitions that frame of lighting data into PDUs consistent with a BIS of a BLE protocol (1506), and transmits the PDUs using a BIS (1508). At least one peripheral device within wireless communications range of the controller receives the BIS (1510). Each of the peripheral devices listens for corresponding subevents of the BIS and ignores other subevents of the BIS (1512). Each peripheral device applies a presentation delay to commands decoded from corresponding bytes of the corresponding subevents (1514) and the peripheral devices execute the lighting commands synchronously (1516).

Thus, techniques that send digital communications for lighting applications using broadcast isochronous links have been described. The techniques may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a disk, tape, or other magnetic, optical, or electronic storage medium.

The description of the invention set forth herein is illustrative and is not intended to limit the scope of the invention as set forth in the following claims. The terms “first,” “second,” “third,” and so forth, as used in the claims, unless otherwise clear by context, is to distinguish between different items in the claims and does not otherwise indicate or imply any order in time, location, or quality. For example, “a first received signal,” “a second received signal,” does not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for communicating data in a network of a plurality of lighting devices, the method comprising:
partitioning a frame of data for a predetermined number of channels into multiple Protocol Data Units (PDUs), each channel of the predetermined number of channels having a predetermined bit width; and
transmitting a broadcast isochronous stream (BIS) including the multiple PDUs, the BIS having a plurality of subevents, each subevent of the plurality of subevents being associated with at least one corresponding channel of the predetermined number of channels.

2. The method as recited in claim 1 wherein each channel of the predetermined number of channels is associated with a corresponding peripheral device of a plurality of peripheral devices.

3. The method as recited in claim 1 wherein the predetermined number of channels corresponds to a Digital Multiplex (DMX) universe associated with the BIS.

4. The method as recited in claim 2 further comprising:
partitioning a second frame of data for a second predetermined number of channels into second multiple PDUs,
wherein the second predetermined number of channels corresponds to a second DMX universe associated with a second BIS, and
wherein the BIS and the second BIS are transmitted as part of a Broadcast Isochronous Group (BIG).

5. The method as recited in claim 4 further comprising:
receiving the BIS by a first peripheral device;
receiving the BIS by a second peripheral device; and
using a presentation delay to synchronously execute a command in the BIS by the first peripheral device and a second command in the BIS by the second peripheral device.

6. The method as recited in claim 1 further comprising:
receiving the BIS; and
selectively processing a subevent of the plurality of subevents and ignoring other subevents of the plurality of subevents.

7. The method as recited in claim 6 further comprising:
retransmitting the multiple PDUs by a first peripheral device; and
executing a command in the subevent by the first peripheral device and a second command in another subevent of the plurality of subevents by a second peripheral device at a time after retransmission of the multiple PDUs by the first peripheral device, the time being based on a first presentation delay and a second presentation delay.

8. The method as recited in claim 1 wherein the BIS is transmitted by a first controller device and the method further comprises:
partitioning a second frame of data for a second predetermined number of channels into a second multiple PDUs;
synchronizing the first controller device and a second controller device using a network timestamp; and
transmitting, by the second controller device, a second BIS including the second multiple PDUs having a second plurality of subevents, each subevent of the second plurality of subevents being associated with a corresponding channel of the second predetermined number of channels; and
synchronously executing a first command of the BIS by a first peripheral device and a second command of the second BIS by a second peripheral device.

9. The method as recited in claim 1 wherein the frame of data includes Digital Multiplex (DMX) data corresponding to audio data and the method further comprises:
transmitting a second isochronous data stream including the audio data; and
synchronously executing commands associated with the data by a first wireless communications device and presenting the audio data by a second wireless communications device.

10. A network comprising:
a controller configured to partition a frame of data for a predetermined number of channels into multiple Protocol Data Units (PDUs), each channel of the predetermined number of channels having a predetermined bit width, and configured to transmit a broadcast isochronous stream (BIS) including the multiple PDUs, the BIS having a plurality of subevents, each subevent of the plurality of subevents being associated with at least one corresponding channel of the predetermined number of channels.

11. The network as recited in claim 10 wherein each channel of the predetermined number of channels is associated with a corresponding peripheral device of a plurality of peripheral devices.

12. The network as recited in claim 10 wherein the predetermined number of channels corresponds to a Digital Multiplex (DMX) universe associated with the BIS.

13. The network as recited in claim 10
wherein the controller is further configured to partition a second frame of data for a second predetermined number of channels into second multiple PDUs, the second predetermined number of channels corresponds to a second DMX universe associated with a second BIS, and the controller is further configured to transmit the BIS and the second BIS as part of a Broadcast Isochronous Group (BIG).

14. The network as recited in claim 10 further comprising:
a first peripheral device configured to receive the BIS; and
a second peripheral device configured to receive the BIS,
wherein the first peripheral device and the second peripheral device are further configured to use presentation delay to synchronously execute a command in the BIS and a second command in the BIS, respectively.

15. The network as recited in claim 10 further comprising:
a first peripheral device configured to receive the BIS, selectively process a subevent of the plurality of subevents, and ignore other subevents of the plurality of subevents.

16. The network as recited in claim 15
wherein the first peripheral device is configured to retransmit the multiple PDUs, and to execute a command in the multiple PDUs, and
wherein a second peripheral device is configured to execute a second command in the multiple PDUs at a time after retransmission of the multiple PDUs by the first peripheral device, the time being based on a first presentation delay and a second presentation delay.

17. The network as recited in claim 15 further comprising:
a second controller configured to partition a second frame of data for a second predetermined number of channels into a second multiple PDUs and to synchronize to the network using a network timestamp, and transmit a second BIS including the second multiple PDUs having a second plurality of subevents, each subevent of the second plurality of subevents being associated with a corresponding channel of the second predetermined number of channels; and
a second peripheral device configured to receive the second BIS and selectively execute a second subevent of the second plurality of subevents synchronously to the subevent and ignore other subevents of the second plurality of subevents.

18. The network as recited in claim 10 further comprising:
an adapter configured to receive DMX frames in a BIS, adjust timing using presentation delay of the BIS, forward the DMX frames to a peripheral device.

19. The network as recited in claim 10 further comprising:
wherein the frame of data includes Digital Multiplex (DMX) data corresponding to audio data,
wherein the controller is further configured to transmit a second isochronous data stream including the audio data.

20. A method for communicating data in a network of a plurality of lighting devices, the method comprising:
receiving a broadcast isochronous stream (BIS) including a plurality of subevents, each subevent of the plurality of subevents being associated with at least one corresponding channel of a predetermined number of channels of a frame of data, each channel of the predetermined number of channels having a predetermined bit width; and
selectively processing a first subevent of the plurality of subevents and ignoring other subevents of the plurality of subevents.

21. The method as recited in claim 20 further comprising:
retransmitting the plurality of subevents by a first peripheral device; and
executing a command in the first subevent by the first peripheral device and a second command in another subevent of the plurality of subevents by a second peripheral device at a time after retransmission of the plurality of subevents by the first peripheral device, the time being based on a first presentation delay and a second presentation delay.
